(19) United States
(12) Patent Application Publication
(10) Pub. No.: US 2004/0080682 A1
(43) Pub. Date: Apr. 29, 2004

(54) Apparatus and method for an improved electronic display

(76) Inventor: Dan L. Dalton, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/283,502

(22) Filed: Oct. 29, 2002

(51) Int. Cl. G02F 1/13

(52) U.S. Cl. 349/58

(57) ABSTRACT

The invention consists of a visual display mounted to a mechanism pivoting about a single point such that the visual display may be rocked to active switches located inside the edges of the visual display. Electronic devices where this invention may be used include, but are not limited to, digital cameras, cell phones, wristwatches, and GPS devices.

### FIELD OF THE INVENTION

This invention relates generally to electronic devices and more specifically to placing switches under electronic displays.

### BACKGROUND OF THE INVENTION

Electronic displays may be found on digital cameras, cell phones, wristwatches, GPSs (Global Positioning Systems), and many other digital devices. Included in the electronic displays available for use are LCDs (Liquid Crystal Displays) and OLED (Organic Light Emitting Diode) displays. Portable electronic devices usually are small. As a consequence, the area on these devices is used very carefully. Each function placed on a portable electronic device should be useful and take up as little space as possible. Functions that may be combined in the same space may help to increase the utility and reduce the size of a portable electronic device. Digital cameras are an example of a portable electronic device that requires space and function to be used carefully.

Digital cameras come in forms small enough and versatile enough to perform almost all of the tasks that conventional cameras can perform, and they can do other things that conventional cameras cannot. The digital camera is ideal for creating pictures that you can e-mail or post on the Internet.

The digital camera can be used much like a conventional film camera. Most digital cameras have more in common with automatic point-and-shoot cameras than they do with professional SLR cameras. They generally have auto-focus, and they can adjust for brightness, shutter speed and aperture automatically.

The “film” of a digital camera is a removable media-storage device (floppy disk, Flash memory card, etc). As with a film camera, you simply replace the storage device when it's full and continue to take pictures. The difference is you don't need to develop digital pictures. You can download them directly to your computer and they are ready to use.

As with film cameras, one of the primary applications of images taken by digital cameras is creating prints. Many digital cameras now have resolutions comparable to 35 mm film. Furthermore, new ink-jet inks and papers can produce prints that surpass conventional silver-halide prints.

If you take pictures in JPEG format at 640×480 resolution, you can download them to your computer and e-mail them to friends without having to do anything to the picture. This eliminates most of the steps you would need to take to do this with a film camera: There's no need to get film developed or scan the developed picture. Just take the picture, transfer it to the computer and e-mail it.

The files that you create with your digital camera can also be posted to the Web. If you have a personal home page, you can display your pictures there. Another good use of the digital camera is taking pictures of things you would like to sell. A digital camera can save you a lot of time and money if you often sell things in online auctions because you can take a picture of an object and post it to the auction site very quickly and without having to pay for film or developing. If you're selling a house or car, you could also post pictures on the Web to help potential buyers see what they are getting.

Many digital cameras contain an electronic display to view an image before taking a photograph. In addition, an electronic display may be used to review photographs taken previously. Many digital cameras have 2 or more “arrow” buttons on the back of the camera next to an electronic display. The arrow buttons are used to navigate through images, menus, and other functions on the digital camera. These arrow buttons work well, but they may result in the camera looking complex, the electronic display being smaller than desired, and the camera being difficult to grip without pressing a button.

There is a need in the art to reduce the area required for arrow buttons and electronic displays. One embodiment of this invention place switches, which act as arrow buttons, under a rocking electronic display. Another embodiment places a transparent cover over a visual display such that the flexible edges of the cover may be pressed to activate switches located under the cover. These innovations clean up and simplify the layout of electronic devices with little, if any, reduction in functionality. A detailed description of these embodiments of this invention is described later.

### SUMMARY OF THE INVENTION

In a preferred embodiment, the invention consists of a visual display mounted to a mechanism pivoting about a single point such that the visual display may be rocked to active switches located inside the edges of the visual display. Electronic devices where this invention may be used include, but are not limited to, digital cameras, cell phones, wristwatches, and GPS devices.

Other aspects and advantages of the present invention will become apparent from the following detailed description, taken in conjunction with the accompanying drawings illustrating by way of example the principles of the invention.

### BRIEF DESCRIPTION OF THE DRAWINGS

FIG. 1 is a diagram of the back of a digital camera. Prior Art

FIG. 2 is a diagram of the back of a digital camera where the visual display pivots to allow selection of switches under the visual display.

FIG. 3 is a diagram of the back of a digital camera where the flexible edges of a transparent cover are used to select switches.

FIG. 4 is a diagram of the back of a digital camera where switches may be activated by placing flexing mechanisms under a transparent cover.

### DETAILED DESCRIPTION OF THE PREFERRED EMBODIMENT

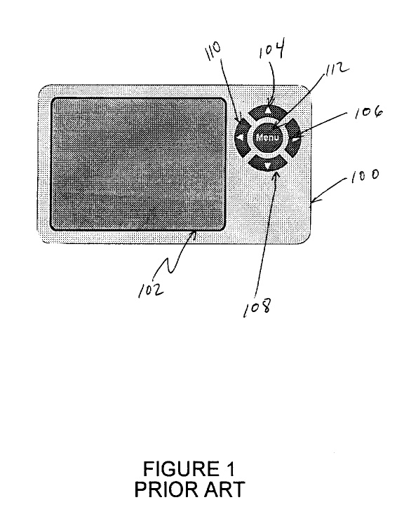

FIG. 1 is a diagram of the back of a digital camera, 100. A visual display, 102, may be used to show what the camera is currently focused on or to display photographs already taken. The “arrow buttons”, 104, 106, 108, and 110 may be used to navigate through images and select options on a menu. An arrow button function is usually realized by using either a mechanical or electrical switch. Activating a switch indicates that a function on the camera is either selected or deselected. In addition, menu switch, 112, may be used to select various menus available to the camera.

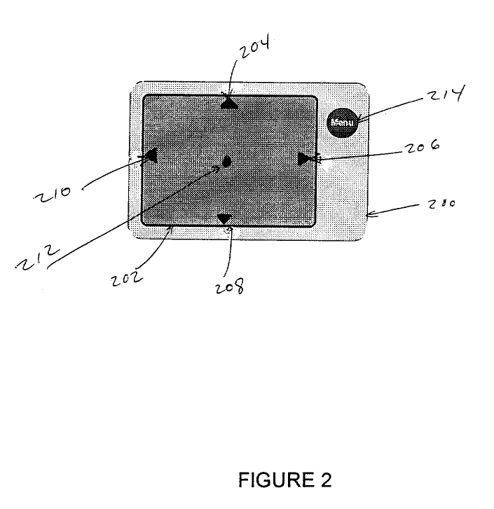

FIG. 2 is a diagram of the back of digital camera, 200, using one embodiment of this invention. A visual display, 202, is mounted to a mechanical pivot, 212, that pivots around a single point. Switches, 204, 206, 208, and 210 are located under the visual display, 202. The right switch, 206, may be activated by pressing on the right edge of the visual display, 202. The left switch, 210, may be activated by pressing on the left edge of the visual display, 202. The upper switch, 204, may be activated by pressing on the upper edge of the visual display, 202. The lower switch, 208, may be activated by pressing on the lower edge of the visual display, 202. In each of these cases, the visual display pivots on the mechanical pivot, 212, located near the center of the display. In addition, menu switch, 214, may be used to select various menus available to the camera

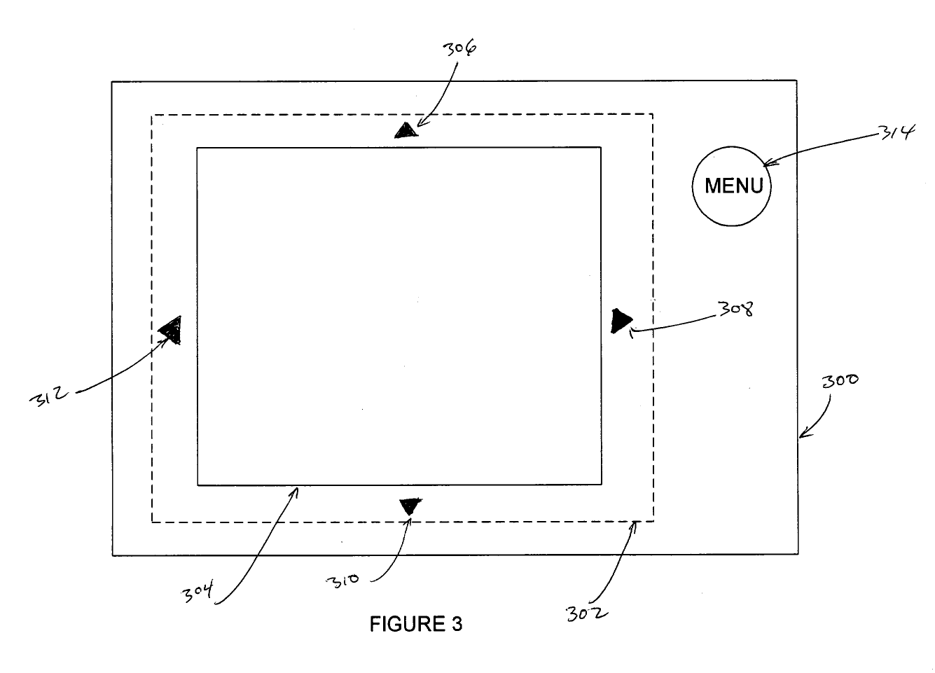

FIG. 3 is a diagram of the back of digital camera, 300, using another embodiment of this invention. A visual display, 304, is mounted to the camera 300. A transparent, flexible, cover, 302, is affixed to the visual display. The edges of the cover, 302, extend beyond the edges of the visual display, 304. Switches, 306, 308, 310, and 312 are located under the cover, 302, beyond the edges of the visual display, 304. The right switch, 308, may be activated by pressing on the right edge of the cover, 302. The left switch, 312, may be activated by pressing on the left edge of the cover, 302. The upper switch, 306, may be activated by pressing on the upper edge of the cover, 302. The lower switch, 310, may be activated by pressing on the lower edge of the cover, 302. In each of these cases, the transparent, flexible cover, 302, flexes near the edges of the visual display to allow the switches, 306, 308, 310, and 312 to be activated. In addition, menu switch, 314, may be used to select various menus available to the camera

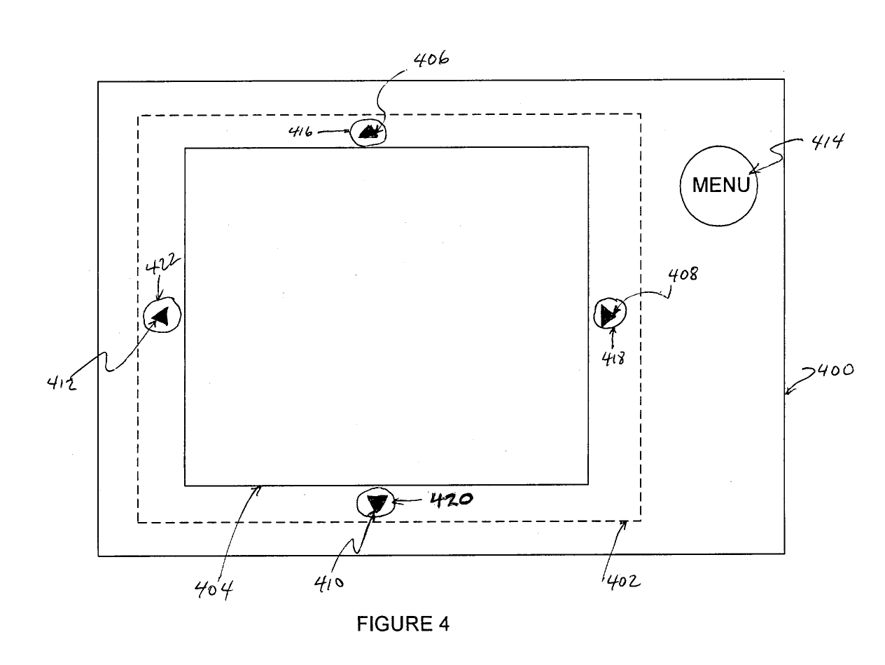

FIG. 4 is a diagram of the back of digital camera, 400, using another embodiment of this invention. A visual display, 404, is mounted to the camera 400. A transparent, cover, 402, is affixed to four flexible mechanisms, 416, 418, 420, and 422. Each of the four flexible mechanisms, 416, 418, 420, and 422 are located under the transparent cover and directly over switches, 406, 408, 410, and 412 respectively. One example of a flexible mechanism is a spring. The switches, 406, 408, 410, and 412 are activated by applying pressure to the areas of the transparent cover, 402 above the flexible mechanisms, 416, 418, 420, and 422. The right switch, 408, may be activated by pressing on the right edge of the cover, 402. The left switch, 412, may be activated by pressing on the left edge of the cover, 402. The upper switch, 406, may be activated by pressing on the upper edge of the cover, 402. The lower switch, 410, may be activated by pressing on the lower edge of the cover, 402. In addition, menu switch, 414, may be used to select various menus available to the camera

The examples shown above make use of four switches to implement embodiments of the invention. The use of four switches is not a limitation and fewer than four switches may be used depending on the embodiment of the invention.

The electronic displays described above may also be used in many other electronic devices such as cell phones, wristwatches, and global positioning systems. Included in the electronic displays available for use are LCDs (Liquid Crystal Displays) and OLED (Organic Light Emitting Diode) displays.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) An electronic display comprising:
a) a visual display pivoting about a point;
b) switches located under each edge of said visual display;
c) wherein said visual display is used to activate said switches.

2) The electronic display of claim 1, wherein:
a) said visual display is a LCD and;
b) said switches are mechanical switches.

3) The electronic display of claim 1, wherein:
a) said visual display is a LCD and;
b) said switches are electronic switches.

4) The electronic display of claim 1, wherein:
a) said visual display is an OLED and;
b) said switches are mechanical switches.

5) The electronic display of claim 1, wherein:
a) said visual display is an OLED and;
b) said switches are electronic switches.

6) The electronic display of claim 1, wherein:
said electronic display is used on a digital camera.

7) The electronic display of claim 1, wherein:
said electronic display is used on a cell phone.

8) The electronic display of claim 1, wherein:
said electronic display is used on a wristwatch.

9) The electronic display of claim 1, wherein:
said electronic display is used on a GPS.

10) An electronic display comprising:
a) a visual display;
b) a transparent flexible cover affixed to said visual display, said cover extending beyond the edges of said visual display;
c) switches located beyond each edge of said visual display and under said transparent flexible cover;
d) wherein said transparent flexible cover is used to activate said switches located under said transparent flexible cover.

11) The electronic display of claim 10, wherein:
a) said visual display is a LCD and;
b) said switches are mechanical switches.

12) The electronic display of claim 10, wherein:
a) said visual display is a LCD and;
b) said switches are electronic switches.

13) The electronic display of claim 10, wherein:
a) said visual display is an OLED and;
b) said switches are mechanical switches.

14) The electronic display of claim 10, wherein:
a) said visual display is an OLED and;
b) said switches are electronic switches.

15) The electronic display of claim 10, wherein:
said electronic display is used on a digital camera.

16) The electronic display of claim 10, wherein:
said electronic display is used on a cell phone.

17) The electronic display of claim 10, wherein:
said electronic display is used on a wristwatch.

18) The electronic display of claim 10, wherein:
said electronic display is used on a GPS.

19) An electronic display comprising:
a) a visual display;
b) a transparent cover extending beyond the edges of said visual display;
c) compressible mechanisms;
d) switches located beyond each edge of said visual display and under said transparent cover;
e) wherein said compressible mechanisms are located under said transparent cover and beyond the edges of said visual display;
f) wherein said transparent cover is used to compress said compressible mechanisms and activate said switches.

20) The electronic display of claim 19, wherein:
a) said visual display is a LCD and;
b) said switches are mechanical switches.

21) The electronic display of claim 19, wherein:
a) said visual display is a LCD and;
b) said switches are electronic switches.

22) The electronic display of claim 19, wherein:
a) said visual display is an OLED and;
b) said switches are mechanical switches.

23) The electronic display of claim 19, wherein:
a) said visual display is an OLED and;
b) said switches are electronic switches.

24) The electronic display of claim 19, wherein said compressible mechanisms are springs.

25) The electronic display of claim 19, wherein:
said electronic display is used on a cell phone.

26) The electronic display of claim 19, wherein:
said electronic display is used on a wristwatch.

27) The electronic display of claim 19, wherein:
said electronic display is used on a GPS.

28) An electronic display comprising:
a) a visual display pivoting about a point;
b) at least one switch located under an edge of said visual display;
c) wherein said visual display is used to activate at least one switch under an edge of said visual display.

29) An electronic display comprising:
a) a visual display;
b) a transparent flexible cover affixed to said visual display, said cover extending beyond the edges of said visual display;
c) at least one switch located beyond an edge of said visual display;
d) wherein said transparent flexible cover is used to activate at least one switch located under said transparent flexible cover and beyond an edge of said visual display.

30) An electronic display comprising:
a) a visual display;
b) a transparent cover extending beyond the edges of said visual display;
c) at least one compressible mechanism;
d) at least one switch located beyond an edge of said visual display and under said transparent cover;
e) wherein at least one compressible mechanism is located under said transparent cover and beyond an edge of said visual display.

31) An electronic display comprising:
a) a visual display;
b) switches located under each edge of said visual display;
c) wherein said visual display is used to activate said switches.

32) An electronic display comprising:
a) a means for visually displaying electronic data, said means pivoting about a point;
b) a means for switching an electrical signal on and off;
c) wherein said means for visually displaying electronic data is used to activate said means for switching an electrical signal on and off.

33) A method for making an electronic display comprising:
a) mounting a visual display on a pivotal mechanism;
b) affixing switches under said visual display.

34) The method of claim 33, wherein:
said visual display is a LCD.

35) The method of claim 33, wherein:
said visual display is an OLED.

36) The method of claim 33, wherein:
said switches are mechanical switches.

37) The method of claim 33, wherein:
said switches are electronic switches.

38) A method for making an electronic display comprising:
a) affixing a transparent flexible cover to a visual display, said cover extending beyond the edges of said visual display;
b) positioning switches such that said switches are located beyond the edges of said visual display and under the edges of said cover;
c) wherein said transparent flexible cover is used to activate said switches located under said transparent flexible cover.

39) The method of claim 38, wherein:
a) said visual display is a LCD and;
b) said switches are mechanical switches.

40) The method of claim 38, wherein:
a) said visual display is a LCD and;
b) said switches are electronic switches.

41) The method of claim 38, wherein:
a) said visual display is an OLED and;
b) said switches are mechanical switches.

42) The method of claim 38, wherein:
a) said visual display is an OLED and;
said switches are electronic switches.
